(19) United States
(12) Patent Application Publication
(10) Pub. No.: US 2006/0118116 A1
(43) Pub. Date: Jun. 8, 2006

(54) Emergency escape mask

(76) Inventor: Michael Porat, Tel Aviv (IL)

Correspondence Address: DENNISON, SCHULTZ, DOUGHERTY & MACDONALD, 1727 KING STREET, SUITE 105, ALEXANDRIA, VA, 22314, US

(21) Appl. No.: 10/529,390

(22) PCT Filed: Sep. 29, 2003
(86) PCT No.: PCT/IL03/00778

§ 371 Date: Mar. 28, 2005

(30) Foreign Application Priority Data
Oct. 2, 2002 (IL) 152060

(51) Int. Cl. A62B 23/02; A62B 7/10

(52) U.S. Cl. 128/205.27; 128/205.29; 128/206.12

(57) ABSTRACT

An escape mask that enables one to breathe filtered air includes a foldable pocket size hood to cover the entire head, including a bag made of transparent plastic film material impermeable to gases, a multi-layered filter assembly containing at least one filter layer containing an antiseptic effective against microorganisms and at least one filter layer containing activated charcoal, the filter assembly being adhered to the bag over an aperture in the bag in the area where the mouth and nose would be for someone wearing the mask, and an exhalation valve embedded in the filter assembly. The mask further includes separate sealing means, not connected to the bag, to seal the bag around the neck, enabling adjustment of the bag over the head to reduce the free space inside the hood and to adjust the exhalation valve against the lips.

In recent years there has been a great increase in terrorist activity in many parts of the world and the weapons used by terrorists have become more sophisticated. Particularly, after Sep. 11, 2001, when the Twin Towers were destroyed in New York City, there is fear that terrorist attacks may take place using chemical and biological weapons. Thus, there has become a need to provide the civilian population with simple and handy emergency means of protection against a sudden chemical and biological terrorist attack. The present invention offers a personal, compact, foldable protective mask for use in the event of the presence of unidentified particles or microorganisms in the atmosphere, which would make normal breathing dangerous.

### BACKGROUND OF THE INVENTION

There are many different types of protective masks containing permanent or replaceable filters on the market. Such masks may be either dust masks or gas masks. Dangerous contaminants may be smoke or fume, chemical substances, and dangerous microorganisms in the form of bacteria or germs. Detailed information regarding such masks can be found in the European Standards for Respiratory Protective Devices (EN-132-1991 to EN-141). Many masks have a serious disadvantage in that they are large and bulky, and in most cases they are bubble shaped (2.2.1.2 in EN-134:1990) to fit over the face only. They are not portable in a pocket or handbag and are transported and stored in specially designed boxes or bags. There are some masks on the market that are flat and foldable. However, these do not seal hermetically and air enters not only via the filter, but also via the space between the mask and the face/skin, particularly in the region of the nose. Because inhaling and exhaling through filters is difficult these masks are produced for protection against only a particular type of dangerous element such as, particles, specific chemicals or microorganisms. The efficiency of most facemasks is significantly reduced when fitted over beards or irregularly shaped or sized faces. If the mask does not properly cover the face, air can penetrate via openings or gaps other than those allowed for by the filters.

Many masks are equipped with exhalation valves, which are one-directional valves for the exhalation of air through the mask. Most existing exhalation valves are generally rigid and increase the dimensions of the masks, making them bulky and inconvenient to carry around.

### PRIOR ART

U.S. Pat. No. 4,038,979 shows a hood mask with a removable filter retained about a frame.

U.S. Pat. No. 4,643,182 discloses a protective mask made of porous non-woven glass fiber with a binding agent including a gas adsorbent substance. One embodiment shows a hood mask with a hem at the bottom for inserting a drawstring to tighten the hood around the neck.

U.S. Pat. No. 5,140,980 teaches a hood mask including a multiple filter assembly with a rigid shell filter support and sealing means attached to the bottom of the hood.

U.S. Pat. No. 6,158,429 disclosed a respirator hood made of elastic fabric material which blocks penetration of liquids and airborne particulate contaminants yet allows the transmission of moisture vapor and heat transfer. The hood also includes at least one HEPA (high efficiency particulate air) filter, at least one transparent lens and a breathe-through airflow valve.

WO 01/62344 discloses a method of decontamination of surfaces exposed to biological warfare agents. One such method is to pass contaminated air through a filtration system incorporating quaternary ammonium compounds.

### SUMMARY OF THE INVENTION

It is an object of this invention to provide a simple, inexpensive, personal mask that enables one to breathe while offering protection from all kinds of contaminated air, whether the contaminant is smoke, unidentified particles, chemical or biological agents or combinations of these.

Another object of the invention is to provide a mask that is adaptable to any user's face size or shape, protecting the entire head and all its orifices including eyes and ears, and only allowing passage of air from outside via a filter.

It is a further object of this invention to provide a hood mask that can be folded to pocket size, like a handkerchief, and that can be carried around all the time in ones pocket or purse, to be taken out and used in an emergency.

Still another object of the invention is to provide a hood mask that is inexpensive and affordable by everyone.

To accomplish all of these objectives, there is provided in accordance with this invention a mask that enables one to breathe filtered air in the presence of contaminated air containing smoke, unidentified particles, chemical and/or biological agents or combinations of these, the mask comprising,
a. a foldable pocket size hood that covers the entire head, said hood comprising,
   1. a bag made of transparent plastic film material impermeable to gases,
   2. a multi-layered filter assembly containing at least one filter layer containing an antiseptic effective against microorganisms and at least one filter layer containing activated charcoal,
   3. an exhalation valve embedded in the filter assembly, and
b. separate sealing means, not connected to the hood, to seal the hood around the neck, enabling adjusting the bag over any size head to reduce the air space inside the hood and to adjust the exhalation valve against the lips.

The mask filters air inhaled by the mouth or nose through the filter, and minimizes the danger of inhalation of air contaminated by chemicals or microorganisms. The exhalation valve makes breathing out easy and reduces fogging and accumulation of humidity inside the mask. Moreover, accumulation of CO₂ inside the mask is also reduced, and air is not allowed to enter the mask. Because the bag is a plastic bag, made from thin plastic film it can be easily folded and kept in a pocket or in a purse ready for immediate use.

Whilst there is an understandable reluctance to pull a plastic bag over ones head due to fear of asphyxiation, the hood of this invention is made of transparent material and incorporates a filter assembly and exhalation valve enabling a person to see and inhale and exhale comfortably. Hence, the hood is safe to pull over the head and cover the face. The bottom of the bag/hood extends down to the neck area, where it is sealed as will be described further on.

The bag/hood can be made of any transparent plastic film such as polyethylene, polypropylene, polyamide, polyester etc. Other materials for the bag can be laminates of different transparent plastic films. It is preferred to use plastics known to be barriers against penetration of gases like polyester, polyamide etc. or laminates containing one of these.

In a preferred embodiment of the mask, the bag is made from laminated films in which at least one of the outer layers of the laminate is a heat sealable film such as polyethylene and one layer is polyamide or other gas barrier film. Such a laminate film enables heat sealing the film to the filter assembly and prevents penetration of contaminated air through the seal. A sandwich laminate in which the outer films are heat seal-able and the inner layer is a gas barrier, like polyamide, is most preferred. Such a laminate can be prepared by inserting film layers that are compatible with both polyethylene and polyamides, between the outer polyethylene layers and the polyamide layer, forming a five layer laminate. One advantage of this laminate is that it does not crackle or make sounds when waved or blown at, which is not the case with two film laminates that crackle (crinkle). Another advantage is that the “sandwich”, laminated with the same film on either side, avoids the bimetal effect and does not fold or crease too easily on its own, making it simpler to pull over the head.

Although the preferred hood is completely transparent, the rear part of the bag and other part not facing the eyes, do not have to be transparent.

The filter layers in the filter assembly can be made from fabric or synthetic non-woven material, paper or any other material used in the manufacture of filters for gas masks. The filters may be round, square, rectangular or irregular in shape.

Preferably, the filter assembly comprises multiple layers of filters. One layer acts as a pre-filter, to filter out large particles that may unnecessarily block passage of air to the next layer, which may be more sensitive and delicate. Another layer filters tiny particles the size of one micron or less. Still another layer contains active charcoal which filters out odors, chemicals, smoke etc. Still At least one filter layer contains an active substance against microorganisms, such as antiseptic material e.g. Chlorhexidine or Cetylpyridinium Chloride (CPC). This layer destroys microorganisms that pass through it. Practically, the positioning of the inner layers is not important, since each layer performs its own filtering action, but preferably the pre-filter which serves to filter the larger particles may be placed in front of the layer that filters the smaller particles. It is also possible to combine the characteristics of two layers into one layer, or even combine all the filtering functions into one layer so that it contains active charcoal, resistance to passage of tiny particles and even antiseptics.

A most preferred filter assembly is one with four layers of filters. This consists of two similar viscose-non-woven polyester outer layers that filter out substances larger than 2 microns. Onto these layers are adsorbed antiseptic materials. One inner filter, containing activated charcoal, and one fine particle filter for filtering out substances larger that 0.3 microns. The combination of these four filters is exceptionally effective also in preventing the passage of microorganisms. A study conducted on the suggested four layer filter assembly demonstrated that there is a synergistic effect of the four layers in prevented the passage of 12 types of microorganisms with an efficacy rate of 99% to 100%. Using the same system for each individual layer, the passage of microorganisms increased 40% and prevented passage of only 60% of the microorganisms.

### BRIEF DESCRIPTION OF THE DRAWINGS

FIG. 1 is a diagram of a hood mask in accordance with this invention,

FIGS. 2-4 show alternative embodiments of hood masks,

FIG. 5 is a cross sectional view of the of the filter assembly,

FIG. 6 is a top view of the filter with exhalation valve,

FIG. 7 is a detailed cross sectional view of the exhalation valve,

FIG. 8 illustrates another embodiment of the exhalation valve,

FIG. 9 shows the exhalation valve of FIG. 8 with a protective cover, and

FIG. 10 is a top view of a cover for the exhalation valve.

### DETAILED DESCRIPTION OF THE INVENTION

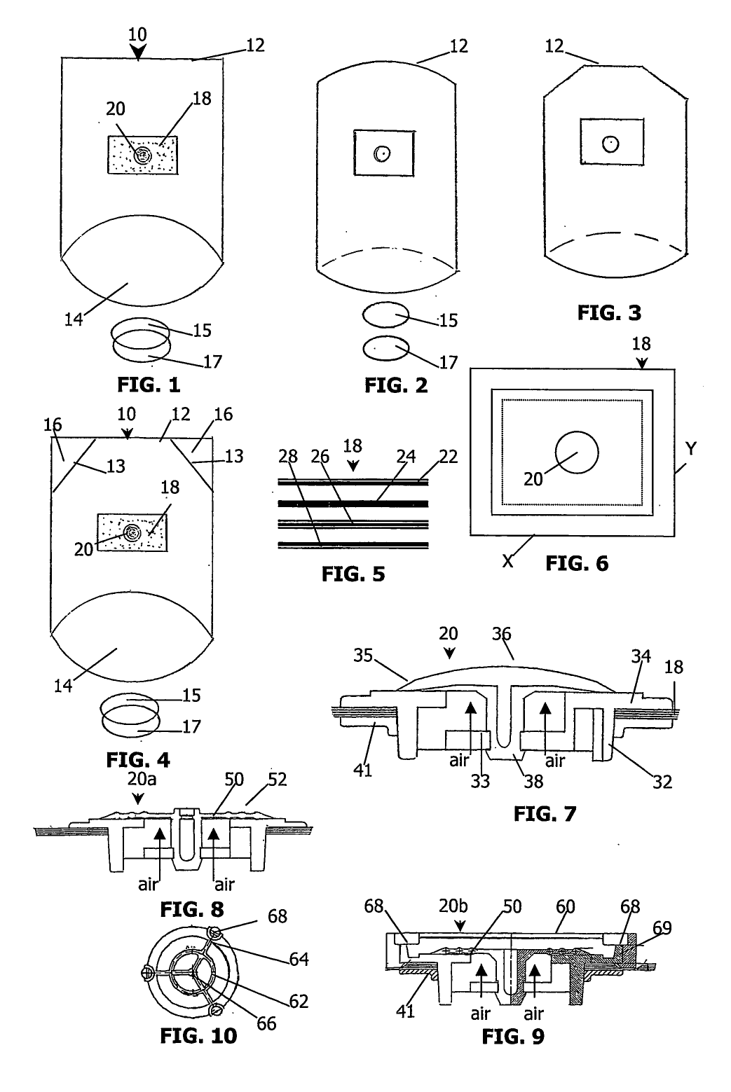

Referring now to FIGS. 1 to 4, there are shown a hood masks 10, in accordance with the invention. The hood 10 is in the shape of a bag with the top 12 of the hood sealed and the bottom 14 open. The top 12 may be square shaped (FIG. 1), slightly curved (FIG. 2) or polygonal (FIG. 3). A pair of elastic bands 15 and 17 is shown, which are to be used to secure the bottom 14 of the hood around the neck. Actually, only one band is required, the other serving as a reserve in case the first one tears or gets lost while unfolding the mask or putting it on. These bands 15 and 17 are supplied together with the folded hood 10 in the same pack.

After the hood 10 is placed over the head, an elastic band 15 is expanded and pulled over the hood 10 and head and down towards the neck. The band 15 is then released and positioned over the bottom section of the bag to seal the plastic around the neck. The band 15 can be made of rubber. In addition to the simplicity and performance of this system, the fact that the elastic band 15 is not connected to the bag, nor does it have to be at the bottom end of the bag, allows flexible placement of the elastic band. This enables sealing the hood with a minimum of air space between the bag and the head even if it is longer than necessary for the particular user. When the closure means are attached to the bottom of the hood, as in the prior art, the tying of the mask is at the base of the bag, so that if the bag is too long for the particular wearer, although the seal around the neck is achieved, there is room for accumulation of exhaled air. In the present invention, the edges of the bag are pulled down, and the elastic band is placed several centimeters over the bottom edges of the bag significantly reducing the mass of air accumulating in the hood compared with the other systems. The separate elastic band allows optimum fit and seal of the mask over the head. Moreover, due to various head sizes, the exhalation filter is not always opposite the mouth and nose. The round shape of the bag facilitates easy adjustment/positioning of the filter in order that it is approximately opposite the mouth and nose by pulling the front layer of the bag upwards or downwards, as necessary. When the filter is opposite the mouth and nose, the elastic band is re-adjusted around the neck minimizing the air mass that can accumulate due to the looseness caused by surplus material around the head. The availability of a second band 17 is useful in case the first one is lost or tears, but even more so because it allows the further sealing of the hood to the head. The elastic bands 15 and 17 are of a size and strength to obtain a good seal and yet avoid chocking the wearer. An elastic circumferential band made of natural latex having a diameter of 85-100 mm, a width of 4-6 mm, and thickness of 0.8-1.8 mm has been found to be very suitable for this purpose.

An additional advantage of the invention, compared to rigid masks, is that while removing the bag off the head with the bands still in place, the bag can be turned inside out, by only touching the uncontaminated surface. Once a user knows that it is safe to take off the mask, it will be removed by handling only the inside of the bag, thereby avoiding touching the possibly contaminated outer material. The end result will be that the contaminated surface will now face inwards and the bag can be safely discarded.

The approximate dimensions of the mask are as follows: height: 460 mm, width: 365 mm. The mask can be folded to minimize its size of about 10-12.5cm×9-11 cm×1-2 cm. So that it can fit into a pocket. The folded mask can be vacuum sealed in an “easy open” pouch.

A preferred embodiment is shown in FIG. 4, where the upper corners 16 of the square top are heat sealed 13 to give a dome shaped inner top. This embodiment is simpler to manufacture by producing a continuous sleeve having the diameter of the bag, cutting bags to size and sealing 13 the top end 12 and the corners 16 in one operation. The corners 16 are superfluous and don't even have to be cut off. On one wall of the bag, near the center thereof and distanced from the top 12 approximately where the mouth of the average person would be, is a filter assembly 18 which will be discussed hereinafter. Inserted in the filter assembly 18 is an exhalation valve 20. In a most preferred embodiment the hood mask 10 is made from a laminate of 5 films—polyethylene:polyvinyl acetate:polyamide:polyvinyl acetate:polyethylene. The polyvinyl acetate binds the polyethylene to the polyamide, which is generally not compatible therewith, to form a single layer of film easily heat sealable, since the polyethylene layers are on the outside.

Referring now to FIGS. 5 and 6, there are shown a filter assembly 18. The filter assembly 18 is comprised of four filter layers 22, 24, 26 and 28. Filters 22 and 28 are identical in that they have a viscose-polyester matrix which filters out particles greater than 2.0 microns. Both filters 22 and 28 are impregnated with antiseptic material, preferably 0.3%-0.7% chlorhexidine salt or 0.3%-0.7% cetylpyridinium chloride. Filter 24 is a non-woven polyester mat filtering out particles greater than 0.3mm. Filter 26 is a non-woven polyester mat containing activated charcoal (200 g/sq.m) with 114 g/sq.m charcoal. Filter layers 22 and 28 are the outside layers and filters 24 and 26 can interchange in the middle. The filter assembly 18, illustrated in FIG. 6 is about 106 mm long (x) and 90 mm high (y), and the exhalation valve 20 about 32 mm in diameter. Looking at FIG. 7, the base 32 of the exhalation valve 20 is inserted into a hole in the filter assembly 18 traversing all the filter layers and protruding on one side of the filter 18. A closure ring 41 is clamped over the base 32 on the other side of the filter. A flexible mushroom diaphragm 36 is snap fitted into the base 32 and held there by the protrusion 33 in the base 32 engaging slots in the mushroom stem 38. Thus, when air is exhaled through the exhalation valve 20 the flexible end 35 of the mushroom diaphragm 36 is lifted and the air flows out of the valve 20. As soon as the exhaling stops, the flexible end 35 flexes down again sealing entry of air to the filter. The area around the base 34 of the valve is rigid and significantly thicker than the rest of the mask frame. This added inflexibility prevents the valve 20 from bending or twisting during breathing or by face movements. The elasticity of the dome of diaphragm 36 is retained, but the base 34 is held firmly in place.

FIG. 8 illustrates another embodiment of the exhalation valve 20a. In this case the flexible diaphragm 50 is not dome shaped but flat with reinforcing ribs 52. This embodiment makes it easier for the less rigid flat diaphragm 50 to return to the closed position and seal the entry of air hermetically.

Turning to FIGS. 9 and 10 there is shown the exhalation valve 20a of FIG. 8 with a protective cover 60 guarding the diaphragm 50 from scratches or other deformation. The cover 60 is a rigid flat ring 62 (FIG. 10) with three equidistant cross bars 64 traversing the center 66 of the ring 62. From the end of the cross bars 64 there extend legs 68 that engage the valve housing 69 and are held therein. This protective cover 60 is important, since the diaphragm 50 can be scratched or otherwise damaged by one fingers or by the elastic bands while placing them over the mask and around the neck. It should be understood that the shape and dimensions illustrated herebefore, are exemplary only. Other shapes and dimensions are also considered with in the scope of the invention.

A different filtering system can be adapted to match the invented mask. Instead of the inhaled suggested filter, the mask can be equipped with an easily applied “screw-on” or “bayonet” connector, either of them to be attached to a combined filter as defined in EN-132 and EN-135 of 1991. In this case, the filter assembly can be supplied separately to be connected to the mask, or it can form an integral part of the mask. The connector can also be used to connect the mask to a fresh air supply hose as defined in EN-135-1991. The advantage of the invented mask compared to the conventional masks as described in EN-132-1991 to EN-405 is its simplicity and inexpensive construction compared to the mentioned masks in the EN standards. The “one size fits all” and the protection of the entire head with all its orifices characterize the simplicity. Even the hood mask as described in the EN-132-1991 to EN-405 is completely different and does not suggest our invented mask.

It is preferable for the exhalation valve to be opposite the mouth and nose, so that the exhaled air will be expelled directly from the mask without mixing with inhaled air contained in the rest of the bag. The exhalation valve is necessary since expelled air will not pass easily through the filters contained in the bag material. If the exhaled air were to leave the mask through the filter without an exhalation valve, the efficiency of the charcoal filter would be reduced, because the moisture in the exhaled air would be partially adsorbed on the charcoal. The exhalation valve allows the passage of air in one direction only and prevents the penetration of air via the mask from outside. The exhalation valve is a round or rectangular frame within the mask.

The bottom of the mask/bag is secured around the neck, preventing entry of external air into the mask. There are several methods of sealing the bag/hood around the neck, but as the bag/hood is worn in cases of emergency, only speedy methods are acceptable. One of the systems is by adding to the bottom part of the bag/hood, at the center of the rear layer, two laces (4 in Fig. I) to be tied around the neck over the outer layers of the bag/hood. The laces can be elastic.

Another system is to fold the lower bottom section of the bag/hood performing a hemline all around the bottom. A lace or string can be threaded through this hemline. After the bag/hood is placed over the head, the laces or strings are drawn thus gathering the plastic around the neck.

Another system is to add an adhesive tape to adhere the edges of the bottom part of the bag/hood to the neck.

A study showed that adding 0.03% CPC to the outer filter layers destroys various bacteria and bacteria spores whether they originate from outside of the filter or from inside (near the mouth and nose).

TABLE 1 shows the seize of different microorganisms tested (mean and standard deviation); diameter of spherical bacteria; length an width of rod shaped bacteria or spores.

TABLE 1

| Type of Microrganism | Size in Micron |
|---|---|
| Staphylococcus cohnii | 0.70 ± 0.08 |
| Streptococcus pyogenes | 0.80 ± 0.16 |
| Pseudomonas fluorescens | 1.50 ± 0.49 × 0.51 ± 0.03 |
| Serratia marcescens | 1.10 ± 0.60 × 0.37 ± 0.04 |
| Bacillus stearothermophilus spores | 0.86 ± 0.13 × 0.53 ± 0.04 |
| Bacillus clausii spores | 1.01 ± 0.13 × 0.57 ± 0.05 |
| Bacillus subtilis spores | 1.25 ± 0.15 × 0.58 ± 0.07 |

The results of negative or negligence growth are shown in TABLE 2.

TABLE 2
Halos of growth inhibition produced by the outer filter.

| Type of Microrganism | Sample 1 | Sample 2 |
|---|---|---|
| Escherichia coli | 0 mm | 0 mm |
| Salmonella enteritidis | 0 mm | 0 mm |
| Serratia marcescens | 0 mm | 0 mm |
| Proteus mirabilis | 1 mm | 1 mm |
| Pseudomonas fluorescens | 0 mm | 0 mm |
| Staphylococcus cohnii | 2 mm | 2 mm |
| Staphylococcus aureus | 3 mm | 2.9 mm |
| Streptococcus pyogenes | 2 mm | 2 mm |
| Enterococcus hirae | 10 mm | 11 mm |
| Bacillus subtilis | 2 mm | 2 mm |
| Bacillus clausii | 8 mm | 8 mm |
| Bacillus stearothermophilus | 8 mm | 9 mm |

It should be understood that the foregoing disclosure relates to only a preferred embodiment of the invention and that it is intended to cover all changes and modifications of the examples of the invention herein chosen for the purpose of the disclosure, which modifications do not constitute departure from the spirit and scope of the invention.

1. An escape mask that enables one to breathe filtered air in the presence of contaminated air containing smoke, unidentified particles, chemical and/or biological agents or combinations of these, the mask comprising,
A. a hood foldable to pocket size that when unfolded can cover the entire head, comprising:
1. a bag made of transparent plastic film material impermeable to gases,
2. a filter assembly capable of filtering contaminated air or particles,
3. an exhalation valve forming part of the mask, and
B. separate sealing means, not attached to the bag, to seal the hood around the neck, enabling adjusting the bag over the head to reduce the free space inside the hood.

2. A mask as in claim 1, wherein the transparent plastic film material is made of a laminate of more than one plastic material.

3-5. (canceled)

6. A mask in claim 1, wherein the hood is transparent only on the part that will be worn opposite the eyes, mouth and nose.

7. (canceled)

8. A mask as in claim 1, wherein the filter assembly is heat sealed onto the bag.

9. A mask as in claim 1, wherein the filter assembly is a multilayered filter assembly containing at least one filter layer containing an antiseptic effective against microorganisms and at least one filter layer containing active charcoal.

10. A mask as in claim 9, wherein the filter assembly comprises an activated charcoal filter layer sandwiched between two filter layers containing an antiseptic that destroys microorganisms.

11. A mask as in claim 9, wherein the antiseptic material is selected from the group consisting of clorhexidine salt and cetylpyridinium chloride.

12. A mask as in claim 1, wherein the filter is in the area of the nose and mouth of someone wearing the mask.

13. A mask as in claim 9, wherein the antiseptic filter layers are able to filter out particles greater than 2 microns.

14. (canceled)

15. A mask as in claim 1, wherein the exhalation valve is embedded in the filter assembly.

16. A mask as in claim 1, wherein the exhalation valve is in the area opposite the lips of someone wearing the mask.

17. (canceled)

18. A mask as in claim 1, wherein the separate sealing means is an elastic band.

19. A mask as in claim 1, wherein the separate sealing means are two elastic bands.

20. A mask as in claim 18, wherein the band is of a size and strength to achieve a good seal and still avoid choking the wearer when placing the band around a neck.

21-22. (canceled)

23. A mask as in claim 1, that can be turned inside out forming a bag after removal from the head, so that the contaminated outside surface will now face inwards.

24-26. (canceled)

27. An escape mask that enables one to breathe filtered air in the presence of contaminated air containing smoke, unidentified particles, chemical and/or biological agents or combinations of these, the mask comprising,
A. a hood foldable to pocket size that when unfolded can cover the entire head, comprising:
1. a bag made of transparent plastic film material impermeable to gases,
2. a connection means, constructed and arranged for connection to a filter cannister or to a source of fresh air,
3. an exhalation valve forming part of the mask, and
B. separate sealing means, not attached to the bag, to seal the hood around the neck, enabling adjusting the bag over a the head to reduce the free space inside the hood.

28. A method of enabling one to breathe filtered air in the presence of contaminated air containing smoke, unidentified particles, chemical or biological agents or combination of these, comprising:
a) providing a foldable hood escape mask with separate elastic sealing means as in claim 1,
b) unfolding the hood and placing it over the head and neck,
c) stretching the separate elastic sealing means over the hood and pulling it over the head around the neck, and
d) adjusting and sealing the hood around the neck by manipulating the hood and elastic means so that the exhalation valve is opposite the lips and mouth and the air space within the hood is reduced to a minimum.
